(19) United States
(12) Patent Application Publication
(10) Pub. No.: US 2010/0328048 A1
(43) Pub. Date: Dec. 30, 2010

(54) WIRELESS REAL TIME INVENTORY SYSTEM AND METHOD THEREFOR

(76) Inventors: Joseph G. Meli, JR., Scottsdale, AZ (US); Jeremiah Connelly, Peoria, AZ (US)

Correspondence Address: WEISS & MOY PC, 4204 NORTH BROWN AVENUE, SCOTTSDALE, AZ, 85251, US

(21) Appl. No.: 12/494,923

(22) Filed: Jun. 30, 2009

(51) Int. Cl. H04Q 5/22

(52) U.S. Cl. 340/10.42

(57) ABSTRACT

An inventory system has a plurality of tag devices. A single tag device is attached to an asset to be tracked for inventory purposes. Each tag device has a unique identification code. Each tag device transmits an identification signal encoded with the unique identification code. A plurality of signal receivers is positioned in a defined area housing a plurality of assets to be monitored for inventory purposes. At least one signal receiver receives the identification signals from each of the plurality of tag devices. A computer system is coupled to the plurality of signal receivers and receives the identification signals from the plurality of receivers to track the number of assets.

### FIELD OF THE INVENTION

This invention relates generally to an inventory system, and, more specifically, to a wireless real time inventory system which uses wireless tags to track items and to automatically re-order items being tracked when the number of items falls below a prescribed level.

### BACKGROUND OF THE INVENTION

Determining the location and or inventory of assets can be important in a variety of different applications. For example, large manufacturing companies typically have warehouses which are used to store inventory. It is important to accurately count inventory and timely locate parts in order to timely and successfully manufacture products.

In a similar manner, certain industries need to have an accurate inventory of supplies in order to maintain proper service. For example, hospitals need to accurately monitor medical supplies in order to ensure that there is a sufficient stock of supplies in case of an emergency. Presently, most hospitals and emergency medical technician (EMT) vehicles have to monitor inventory manually. For example, in an Emergency Room, the hospital staff monitors every medical supply used and writes this information down in order to monitor medical supply inventories. Likewise, before every shift, an EMT Personnel has to manually take inventory of the supplies on the EMT vehicle to ensure that the EMT vehicle is properly stocked and that no supplies are missing. This is a very time consuming and arduous task.

Therefore, a need exists to provide a device and method to overcome the above problems. The system and method will provide a wireless real time inventory system.

### SUMMARY OF THE INVENTION

In accordance with one embodiment, an inventory system has a plurality of tag devices. A single tag device is attached to an asset to be tracked for inventory purposes. Each tag device has a unique identification code. Each tag device transmits an identification signal encoded with the unique identification code. A plurality of signal receivers is positioned in a defined area housing a plurality of assets to be monitored for inventory purposes. At least one signal receiver receives the identification signals from each of the plurality of tag devices. A computer system is coupled to the plurality of signal receivers and receives the identification signals from the plurality of receivers to track the number of assets.

In accordance with another embodiment of the present invention, a method for tracking inventory is disclosed. The method comprising: installing a tag device on each asset to be tracked for inventory, each tag device having a unique identification code, each tag device transmitting an identification signal encoded with the identification code; installing signal receivers in a proximity of a well defined area housing the asset; attaching a computer system to the plurality of signal receivers; receiving the identification signals by at least one of the signal receivers; and receiving the location signals received by the signal receivers by the computer system to track an inventory of the assets.

In accordance with one embodiment, an inventory system an inventory system has a plurality of tag devices. A single tag device is attached to an asset to be tracked for inventory purposes. Each tag device has a unique identification code. Each tag device transmits an identification signal encoded with the unique identification code. At least one portable signal receiver receives the identification signals from each of the plurality of tag devices to track the number of assets.

The features, functions, and advantages can be achieved independently in various embodiments of the disclosure or may be combined in yet other embodiments.

### BRIEF DESCRIPTION OF THE DRAWINGS

Embodiments of the disclosure will become more fully understood from the detailed description and the accompanying drawings, wherein:

FIG. 1 is a simplified block diagram of one embodiment of the present invention;

FIG. 2 is a simplified bock diagram of a tag device and a handheld reader forming a part of the present invention;

FIG. 3 is a simplified block diagram of the present invention installed in a fire station setting; and

FIG. 4 is a flow chart showing operation of the present invention.

### DETAILED DESCRIPTION OF THE PREFERRED EMBODIMENTS

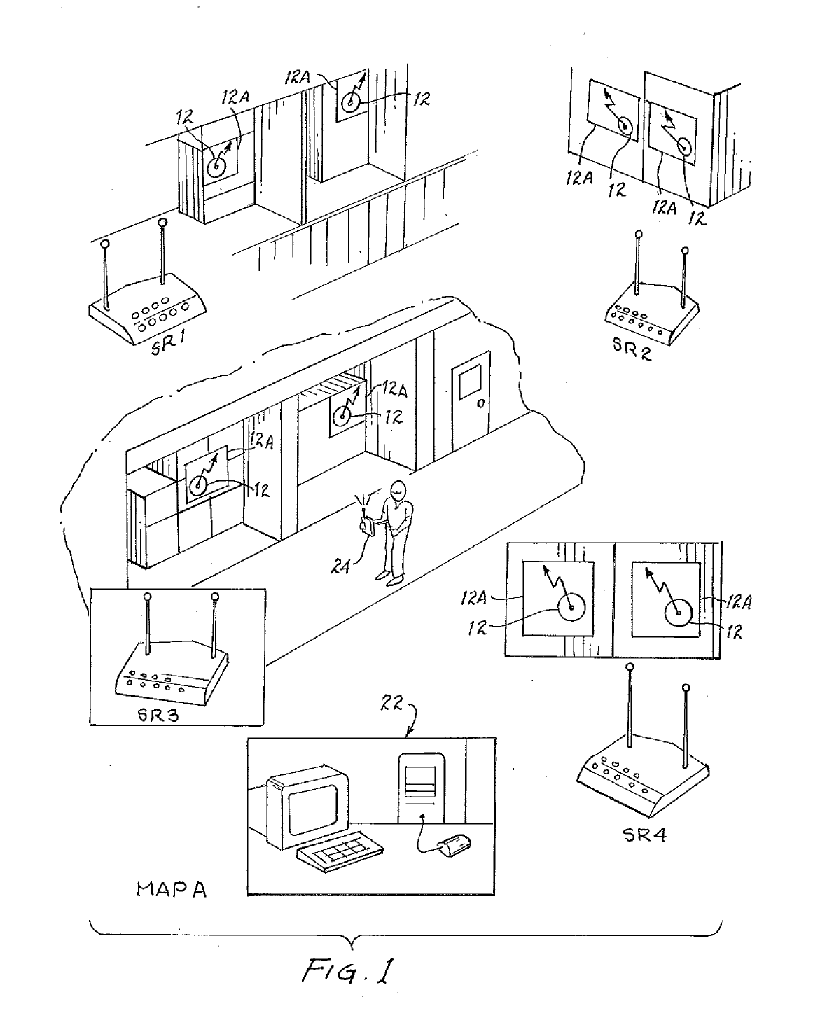

Referring to FIG. 1, a wireless inventory system 10 is installed in an area defined as Map A. The area Map A may be any type of open or closed area. While FIG. 1 shows a single floor, the system 10 may be installed in a multiple floor area and or building. In the present embodiment, the system 10 will be described in a hospital setting wherein the system 10 is used to track the inventory of medical supplies. However, this should not be seen as to limit the scope of the present invention. The system 10 may be installed in any area to monitor any type of inventory supply. In accordance with another embodiment, the system 10 may be installed in any area to monitor an inventory supply as well as to locate a particular asset of the inventory supply.

The system 10 will have a plurality of tag devices 12. Each tag device 12 is attached on each asset 12A, or group of assets that needs to be tracked for inventory purposes. In the embodiment depicted in FIG. 1, eight tag devices 12 are shown. However, this should not be seen as to limit the scope of the present invention. The number of tag devices 12 will be dictated by the number of items need to be tracked for inventory purposes.

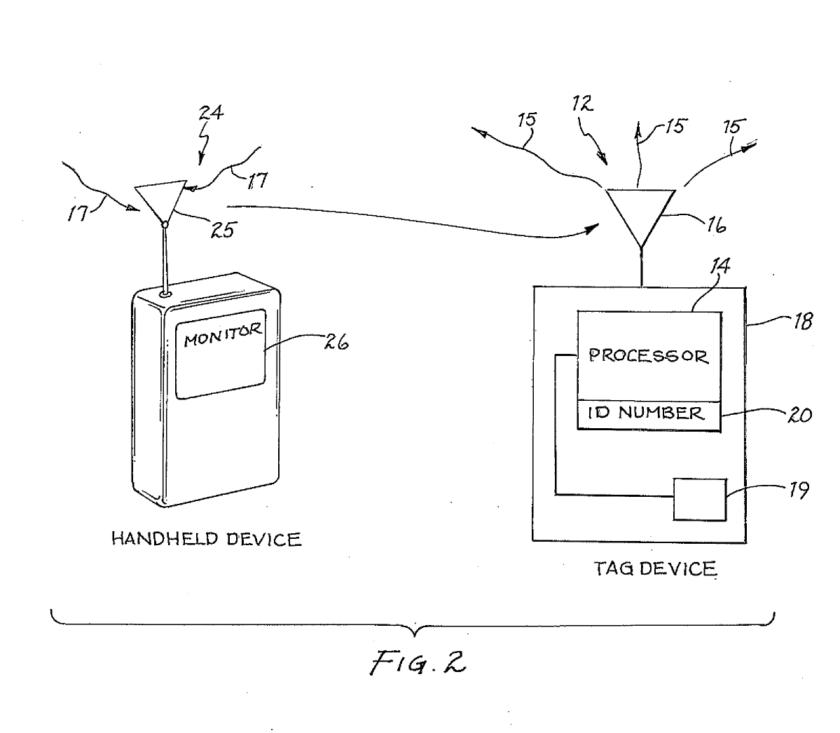

As shown in FIG. 2, each tag device 12 is an electronic device that containing a microprocessor 14 combined with an antenna 16 housed in a compact package 18. A power supply 19 may be attached to the microprocessor 14 for powering the tag device 12. The packaging 18 is structured to allow each tag device 12 to be attached to the asset 12A (FIG. 1) to be tracked. Each microprocessor 14 of each tag device 12 will be encoded with a unique ID 20. The tag device 12 will transmit a signal 15 encoded with the unique ID 20 which is used for inventory tracking. In accordance with one embodiment, if the system 10 is used for inventory tracking as well as asset location, once the tag device 12 is activated, the tag device 12 will transmit the signal 15 encoded with the unique ID 20 which may be used both for inventory tracking as well as location tracking of the asset 12A.

Referring back to FIG. 1, a plurality of signal receivers SR#1-SR#4 is installed in the area defined as Map A. In the embodiment depicted in FIG. 1, four signal receivers SR#1-SR#4 are shown. However, this should not be seen as to limit the scope of the present invention. The number of signal receivers SR#1-SR#4 is generally dictated by the size of the area defined as Map A and the strength and range of each signal receiver SR#1-SR#4. The signal receivers SR#1-SR#4 may be just receivers or in accordance with another embodiment, receivers and transmitters.

The signal receivers SR#1-SR#4 are placed in fixed locations in the area defined as Map A. In accordance with one embodiment, the signal receivers SR#1-SR#4 are used to receive the signal 15 encoded with the unique ID 20 from the tag devices 12. Each of the signal receivers SR#1-SR#4 are coupled to a main computer unit 22. Each of the signal receivers SR#1-SR#4 may be wired to a main computer unit 22. Alternatively, each of the signal receivers SR#1-SR#4 may wireless transmit a signal to the main computer unit 22. In the embodiment shown in FIG. 1, each of the signal receivers SR#1-SR#4 wirelessly transmit a signal to the main computer unit 22.

The main computer unit 22 will monitor and record the signals 15 encoded with the unique IDs 20 received by the signal receivers SR#1-SR#4. The main computer unit 22 may use the unique ID 20 encoded in the signals to track the inventory of assets 12A in the defined area Map A. When the main computer unit 22 determines that the amount of a specific asset falls below a predefined level, the main computer unit 22 may automatically send a communication to order more of the specific asset.

For example, the system 10 may be used in a hospital setting wherein the system 10 is used to track the inventory of medical supplies. All of the medical supplies will have a tag device 12 encoded with a unique ID 20. The main computer unit 22 will monitor and record the signals 15 encoded with the unique IDs 20 received by the signal receivers SR#1-SR#4 and uses the unique IDs 20 for tracking the medical supply inventory. If the main computer unit 22 determines that the amount of a specific medical supply (i.e., a specific drug, medical device, etc.) falls below a predefined level based on the monitor and record the signals 15, the main computer unit 22 may automatically order more of the specific asset. For example, the main computer unit 22 may send an email to the requisite medical supplier to order additional quantities, the main computer unit 22 may send an electronic call to the requisite medical supplier to order additional quantities, a text message or the like. The above listing is given as an example and should not be seen as to limit the scope of the present invention.

Referring now to FIG. 1 and 2, in accordance with another embodiment, the signal receivers SR#1-SR#4 are placed in fixed locations in the area defined as Map A. In this embodiment, the signal receivers SR#1-SR#4 are used to receive the signal 15 encoded with the unique ID 20 from the tag devices 12. Each of the signal receivers SR#1-SR#4 are coupled to a main computer unit 22. Each of the signal receivers SR#1-SR#4 may be wired to a main computer unit 22. Alternatively, each of the signal receivers SR#1-SR#4 may wireless transmit a signal to the main computer unit 22. The main computer unit 22 will monitor and record the signals 15 encoded with the unique IDs 20 received by the signal receivers SR#1-SR#4 for inventory tracking as well as ordering of medical supplies if the main computer unit 22 determines that the amount of a specific medical supply (i.e., a specific drug, medical device, etc.) falls below a predefined level.

In accordance with another embodiment, a handheld mobile device 24 (hereinafter device 24) may be used to receive the signal 15 encoded with the unique ID 20 from the tag devices 12. The device 24 may be used for monitoring smaller areas such as a specific room in Map A or in mobile applications which will be described below. The device 24 may lessen the cost of installing the system 10 if used individually as the signal receivers SR#1-SR#4 would not have to be installed. The device 24 may be used individually or in conjunction with the signal receivers SR#1-SR#4.

The device 24 may have an antenna 25 to receive the signal 15 encoded with the unique ID 20 from the tag devices 12. The antenna 15 may be coupled to a processor circuit which may be used to monitor and record the signals 15 encoded with the unique IDs 20 for inventory tracking. The processor circuit may further perform ordering of medical supplies if it is determined that the amount of a specific medical supply (i.e., a specific drug, medical device, etc.) falls below a predefined level. The processor circuit may send a wireless signal to order the supplies such through a cellular network.

In accordance with another embodiment, the signal receivers SR#1-SR#4 may further be used to locate a desired asset 12A. If a desired asset 12A having a tag device 12 is in a range of one or more of the location receivers SR#1-SR#4, the in range location receivers SR#1-SR#4 will receive the encoded location signal 15 sent by the tag device 12. The in range location receivers SR#1-SR#4 will then determine the location of the tag device 12 and hence the asset 12A. The location method used to locate the activated tag 12 may be any commonly used wireless location method.

In this embodiment, the device 24 may use the antenna 25 to locate the asset 12A. A user may enter a desired ID 20 of a particular asset 12 to locate. Alternatively, the user may enter a specific asset 12A to locate in the device 24. The device 24 will then direct a user to the desired asset 12A. Different methods may be used for the device 24 to locate a desired asset 12A.

In accordance with one embodiment, when a user enters a desired ID 20 of a particular asset 12 to locate, the device 24 sends a signal to the signal receivers SR#1-SR#4. The signal receivers SR#1-SR#4 will then transmit location date of the specified ID 20 of the particular asset 12A. The device 24 will receive the location data signals 17 transmitted by the in range signal receivers SR#1-SR#4 and direct the person to the particular asset 12A.

If a user enters a specific asset 12A to locate in the device 24, the device 24 sends a signal to the signal receivers SR#1-SR#4. The signal receivers SR#1-SR#4 will then transmit location date for the particular asset 12A. The device 24 will direct a person to the desired asset 12 having the strongest signal.

The device 24 may have a monitor 26. The monitor 26 will give visual data to further help a person locate the asset having the activated tag device 12. Using the location data signals 17 transmitted by the in range location receivers SR#1-SR#4 will allow a person using the device 24 to get in a general vicinity of the asset having the activated tag device 12. Locations methods such as RSSI, TOA, TDOA may be used to locate the activated tag device 12.

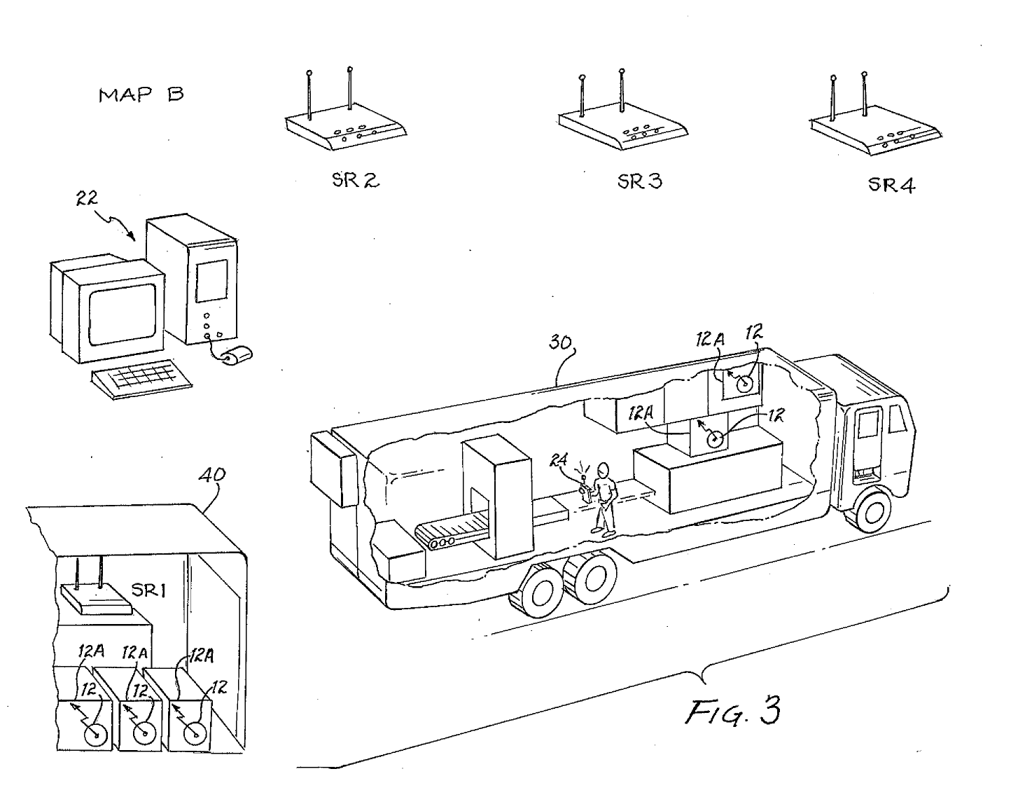

Referring now to FIGS. 2 and 3, the system 10 may be used in an Emergency Medical Technician (EMT) Vehicle, Ambulance, Paramedic Vehicle, or the like (hereinafter EnMT Vehicle 30). The system 10 will be installed in a building and or garage 32 housing the EMT vehicle 30 such as a fire station or the like. In general, at the beginning or end of a shift, each EMT vehicle 30 needs to have an inventory done on all assets 12A in the EMT vehicle. Presently, this is done manually by an EMT personnel which is extremely arduous and time consuming. Using the system 10 will save time and effort and eliminate the need for manually counting the assets 12A in the EMT vehicle 30.

The system 10 will have signal receivers SR#1-SR#4 placed in fixed locations in the area defined as Map B. In the present embodiment, Map B is a building and or garage 32 housing the EMT vehicle 30 such as a fire station or the like. In accordance with one embodiment, the signal receivers SR#1-SR#4 are used to receive the signal 15 encoded with the unique ID 20 from the tag devices 12 placed on all assets 12A to be monitored. In this embodiment, the signal receivers SR#1-SR#4 are used to receive the signal 15 encoded with the unique ID 20 from the tag devices 12 placed on all assets 12A in the EMT vehicle 30. Alternatively, the signal receivers SR#1-SR#4 are used to receive the signal 15 encoded with the unique ID 20 from the tag devices 12 placed on all assets 12A in the EMT vehicle 30 as well as supply storage areas 40 in the fire station which may be used to store additional assets 12A.

Each of the signal receivers SR#1-SR#4 are coupled to a main computer unit 22. Each of the signal receivers SR#1-SR#4 may be wired to a main computer unit 22. Alternatively, each of the signal receivers SR#1-SR#4 may wireless transmit a signal to the main computer unit 22. The main computer unit 22 will monitor and record the signals 15 encoded with the unique IDs 20 received by the signal receivers SR#1-SR#4. The main computer unit 22 may use the unique ID 20 encoded in the signals for inventory tracking of the assets 12A. When the main computer unit 22 determines that the amount of a specific asset falls below a predefined level, the main computer unit 22 may automatically send a communication to order more of the specific asset 12A.

Like in the embodiment discussed above, a handheld mobile device 24 (hereinafter device 24) may be used to receive the signal 15 encoded with the unique ID 20 from the tag devices 12. The device 24 may be used for monitoring the EMT vehicle 30 in areas outside of where the signal receivers SR#1-SR#4. Thus, the device 24 may be used when the EMT vehicle 30 is on a call to monitor the supplies used or to restock the EMT vehicle with supplies in remote locations. The device 24 may lessen the cost of installing the system 10 if used individually as the signal receivers SR#1-SR#4 would not have to be installed. The device 24 may be used individually or in conjunction with the signal receivers SR#1-SR#4.

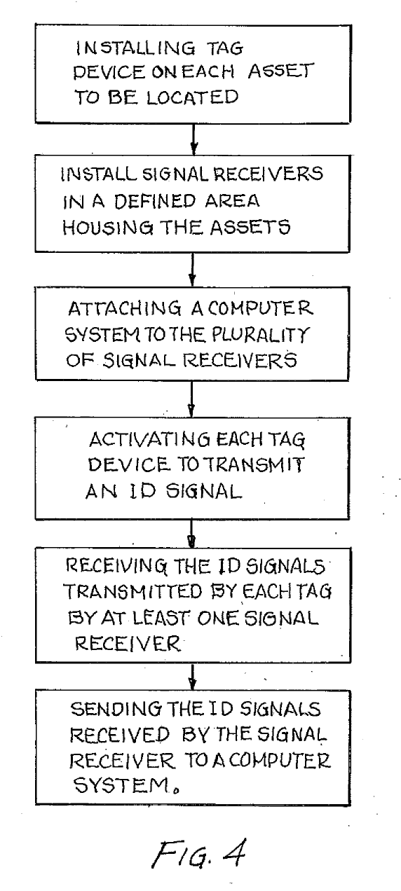

Referring now to FIGS. 1-4, the operation of the system 10 will be disclosed in further detail. A tag device 12 is attached on each asset 12A to be tracked for inventory, Each tag device 12 has a unique identification code 20. Each tag device 12 will transmit an identification signal 15 encoded with the identification code when activated. A plurality of signal receivers SR#1-SR#4 is installed in proximity of a well defined area Map A/Map B housing the assets 12A. A computer system 22 is coupled to the plurality of signal receivers. Alternatively, a device 24 may be used either alone or in conjunction with the signal receivers SR#1-SR#4. The identification signals 15 transmitted by each tag device 12 will be received by at least one of the signal receivers SR#1-SR#4 and or by the device 24. The identification signals 15 received by the signal receivers SR#1-SR#4 are then sent to a computer system 22. The computer system 22 will use these identification signals 15 to track an inventory of the assets 12A. Alternatively, the device 24 may receive the signal 15 encoded with the unique ID 20 from the tag devices 12 and monitor and record the signals 15. The device 24 may further perform ordering of medical supplies if it is determined that the amount of a specific medical supply (i.e., a specific drug, medical device, etc.) falls below a predefined level. The device 24 may send a wireless signal to order the supplies such through a cellular network.

While the system 10 was disclosed in relation to a hospital and EMT vehicle, it should be noted that the system 10 may be used in other applications. For example, the system 10 may be used in a distribution system where a delivery vehicle is loaded with supplies to be delivered to one or more locations. The system 10 may be used to monitor the supplies being loaded onto a truck as well as to monitor which supplies have been delivered to a particular store/location using permanent and or mobile signal receivers. The system 10 may be used in an airport or in a parcel delivery location to monitor luggage or parcels loaded unto a vehicle and to monitor the luggage or parcels at the delivery location. The above are given as examples and should not be seen in a limiting scope as the system 10 may be used in other situations where monitor of assets is desirable.

While embodiments of the disclosure have been described in terms of various specific embodiments, those skilled in the art will recognize that the embodiments of the disclosure can be practiced with modifications within the spirit and scope of the claims.

What is claimed is:

1. An inventory system comprising:
a plurality of tag devices, wherein a single tag device is attached to an asset to be tracked for inventory purposes, each tag device has a unique identification code, each tag device transmitting an identification signal encoded with the unique identification code;
a plurality of signal receivers positioned in a defined area housing a plurality of assets to be monitored for inventory purposes, wherein the at least one signal receiver receives the identification signals from each of the plurality of tag devices; and
a computer system coupled to the plurality of signal receivers which receives the identification signals from the plurality of receivers to track the number of assets.

2. An inventory system in accordance with claim 1 wherein the computer system orders a specific asset when an inventory of the specific asset is below a predetermined number.

3. An inventory system in accordance with claim 1 wherein each tag devices comprises:
a processor, wherein the processor is encoded with the identification code; and
an antenna coupled to the processor for transmitting the location signal.

4. An inventory system in accordance with claim 3 wherein each tag devices further comprises a power supply.

5. An inventory system in accordance with claim 1 further comprising a handheld location reader, wherein a user may enter the unique identification code of a specific asset, the signal location reader which receives location data transmitted by the plurality of signal receivers to guide the user to the specific asset.

6. An inventory system in accordance with claim 5 wherein the signal receivers use one of RSSI or TDOA to locate the tag device.

7. An inventory system in accordance with claim 1 wherein the plurality of signal receivers is positioned around a perimeter of a garage area of a fire station to monitor an inventory of assets stored in an EMT vehicle.

8. An inventory system in accordance with claim 7 wherein the plurality of signal receivers is positioned around a perimeter of a garage area of a fire station to monitor an inventory of assets stored in an EMT vehicle and a storage area of the fire station.

9. An inventory system in accordance with claim 1 wherein the plurality of signal receivers is positioned around a perimeter of a garage area of a fire station to monitor an inventory of assets stored in an EMT vehicle.

10. An inventory system in accordance with claim 1 wherein the plurality of signal receivers is positioned around a perimeter of a hospital floor area to monitor an inventory of assets stored on the hospital floor area.

11. An inventory system comprising:
a plurality of tag devices, wherein a single tag device is attached to an asset to be tracked for inventory purposes, each tag device has a unique identification code, each tag device transmitting an identification signal encoded with the unique identification code;
a plurality of signal receivers positioned in a defined area housing a plurality of assets to be monitored for inventory purposes, wherein at least one signal receiver receives the identification signals from each of the plurality of tag devices; and
a computer system coupled to the plurality of signal receivers which receives the identification signals from the plurality of receivers to track the number of assets and order a specific asset when an inventory of the specific asset is below a predetermined number;
wherein each tag devices comprises:
a processor, wherein the processor is encoded with the identification code; and
an antenna coupled to the processor for transmitting the location signal.

12. An inventory system in accordance with claim 11 wherein each tag devices further comprises a power supply.

13. An inventory system in accordance with claim 11 further comprising a handheld location reader, wherein a user may enter the unique identification code of a specific asset, the signal location reader which receives location data transmitted by the plurality of signal receivers to guide the user to the specific asset.

14. An inventory system in accordance with claim 5 wherein the signal receivers use one of RSSI or TDOA to locate the tag device.

16. A method for tracking inventory comprising:
installing a tag device on each asset to be tracked for inventory, each tag device having a unique identification code, each tag device transmitting an identification signal encoded with the identification code;
installing signal receivers in a proximity of a well defined area housing the asset;
attaching a computer system to the plurality of signal receivers;
receiving the identification signals by at least one of the signal receivers; and
receiving the location signals received by the signal receivers by the computer system to track an inventory of the assets.

17. The method of claim 16 further comprising ordering additional inventory when a number of a specific asset falls below a predetermined number.

18. The method of claim 16 further comprising:
entering a desired identification code into a location reader; and
transmitting location data of a specific tag device having the desired identification code by the signal receivers to the location reader.

19. An inventory system comprising:
a plurality of tag devices, wherein a single tag device is attached to an asset to be tracked for inventory purposes, each tag device has a unique identification code, each tag device transmitting an identification signal encoded with the unique identification code;
at least one portable signal receiver that receives the identification signals from each of the plurality of tag devices to track the number of assets.

20. An inventory system in accordance with claim 19 wherein the at least one portable signal receiver orders a specific asset when a number of the specific asset is less than a specified number.
